(19) United States
(12) Patent Application Publication
(10) Pub. No.: US 2008/0230961 A1
(43) Pub. Date: Sep. 25, 2008

(54) METHOD FOR PRODUCING A MULTI-CHAMBER SYRINGE WITH A BY-PASS CHANNEL

(76) Inventors: Thomas Moesli, St. Gallen (CH); Raffael Dudler, St. Gallen (CH); Peter Wolbring, St. Wendel (DE)

Correspondence Address: HARNESS, DICKEY & PIERCE, P.L.C., P.O. BOX 828, BLOOMFIELD HILLS, MI, 48303, US

(21) Appl. No.: 12/048,924

(22) Filed: Mar. 14, 2008

(30) Foreign Application Priority Data
Mar. 19, 2007 (DE) 10 2007 014 281.3

(51) Int. Cl. B29C 49/16; B29C 49/08

(52) U.S. Cl. 264/524; 264/526; 264/528

(57) ABSTRACT

A method for producing a multi-chamber syringe with a by-pass channel from a plastic material comprises the steps of producing a tubular preform from a thermoplastic material; providing a die designed to enclose the preform from the outside in an area of the by-pass channel to be formed, the at least one by-pass channel being preformed as a recess on an inner surface of the die; heating-up the preform to a temperature above the softening range of the plastic material, and positioning the preform in a predefined axial position inside the die; subjecting the preform to a differential pressure until the at least one by-pass channel is plastically formed; and cooling down the syringe body so formed to room temperature.

### BACKGROUND OF THE INVENTION

The present invention relates to a method for producing a multi-chamber syringe with a by-pass channel from a plastic material.

Factory pre-filled multi-chamber syringes are in use in medicine for dispensing preparations that consist of a plurality of components. As a rule, there are two components that have to be mixed in the syringe in liquid/liquid combination or in solid/liquid combination prior to being dispensed. Such syringes provide the advantage that the components can be mixed without transfer to a different container, and can then be dispensed directly from the container. A two-chamber syringe comprises a tubular, generally cylindrical space which is partitioned into a first chamber and a second chamber by a partitioning element made from an elastomeric material. A by-pass channel is provided in the area of the first chamber, ending in a discharge opening. When a substance stored in the second chamber is displaced toward the first chamber by actuation of a plunger that closes the second chamber to the outside, then the partitioning element will move together with the plunger until it reaches the area of the by-pass channel in a first step. In that position, the substances are allowed to flow over between the first chamber and the second chamber, through the by-pass channel, so that the substances come to be mixed. The process of uniting the two substances is completed when the sealing element of the plunger comes into contact with the partitioning element. The two sealing elements can then be displaced together up to the discharge end of the cylinder of the syringe, for evacuation of the syringe.

There have been known in the art a number of two-chamber syringes consisting of glass (compare EP 0 718 002 B1 and EP 0 856 324 A2) or of a plastic material (compare US 2003/0060749 A1), for example.

While the production of multi-chamber syringes made from glass is relatively expensive, due to the complex production processes, a two-chamber syringe according to EP 0 718 002 B1 is composed from two partial cylinders that are at first filled independently one from the other and are assembled only thereafter. While this in fact allows the risk known as cross contamination to be reduced, the production process is relatively complex and expensive.

In the case of the two-chamber syringe known from EP 0 556 034 A1, the syringe is produced as a single piece by injection-molding. The way in which the by-pass channel is produced is, however, not disclosed by that publication.

Forming undercuts in the interior of injection-molded parts using so-called collapsible core systems has been generally known in the art (compare DE 29 25 858 A1).

However, the use of such collapsible core systems is extremely cost and maintenance-intensive and in many cases not sufficiently reliable. Small syringe formats do not allow the use of a collapsible core system there being not sufficient room to accommodate the mechanical collapsing system in the core. And production cost and tooling costs are also considerably higher than in the case of syringe bodies without a by-pass channel.

### SUMMARY OF THE INVENTION

It is a first object of the present invention to provide a method for producing a multi-chamber syringe with a by-pass channel from a plastic material which allows simple and low-cost production in large numbers.

It is a second object of the invention to disclose provide a method for producing a multi-chamber syringe with a by-pass channel from a plastic material that allows for a highly precise production meeting tight geometrical tolerances.

The invention achieves these and other objects by a method for producing a multi-chamber syringe with a by-pass channel from a plastic material comprising the following steps:
producing a tubular preform, preferably by injection-molding, from a thermoplastic material;
providing a die designed to enclose the preform from the out-side in an area of a by-pass channel to be formed, the at least one by-pass channel being preformed as a recess on the inner surface of the die;
heating-up the preform to a temperature above the softening range, preferably a temperature within the thermoforming range, of the plastic material, and positioning the preform in a predefined axial position inside the die;
subjecting the preform to a differential pressure until the at least one by-pass channel is plastically formed; and

cooling down the syringe body so formed to room temperature.

The object of the invention is perfectly achieved in this way.

According to the invention, the preform is initially formed from a thermoplastic material in a manner known as such, preferably by injection-molding. Thereafter, the preform is deformed, in the area of the at least one bypass channel to be formed, by application of pressure and temperature using a die so that the at least one by-pass channel is plastically formed by the plastic material flowing into contact with the inner surface of the die in which the by-pass channel is preformed as a recess. This permits a multi-chamber syringe made from a plastic material to be produced at low cost, without taking recourse to collapsible core systems. In addition, the process is suited for production in large numbers.

According to an advantageous further development of the invention, the preform is subjected to an overpressure from the inside, for forming the at least one by-pass channel.

This can be achieved using an overpressure of, for example, at least 1 bar, preferably at least 1.5 bar, more preferably at least 2 bar, most preferably at least 2.5 bar. The pressure used is of course influenced by the plastic material employed and by the temperature at which flowing occurs.

The maximum pressure during the process of forming the bypass channel from the preform is limited by the equipment used and is, preferably, in the range of 10 bar, more preferably 8 bar max., more preferably 5 bar max., most preferably 4 bar max.

The temperature employed for forming the at least one by-pass channel depends on the particular plastic material used and is, preferably, in the range of between 120° and 220° Celsius, depending on the type of plastic material used, more preferably in the range of between 140° and 200° Celsius, more preferably in the range of between 160° and 180° Celsius, most preferably approximately 170° Celsius, in case a linear or cyclic olefinic polymer or copolymer is used, for example.

According to another embodiment of the invention, exposure of the heated preform to a differential pressure occurs for a period of time of between 0.5 and 10 seconds, preferably between 1 and 5 seconds, for forming at least one by-pass channel, the wall thickness of the preform in the area of the at least one by-pass channel being selected between 0.5 and 2 mm, for example.

According to a further embodiment of the invention, the preform is subjected to a partial vacuum from the outside for forming the at least one bypass channel.

Although in this case the pressures achievable are not as high as when the channel is formed by application of pressure from the inside, the maximum pressure of at least 1 bar is still sufficient to reliably form the at least one by-pass channel provided a suitable plastic material is used.

Preferably, the preform has a substantially cylindrical shape and comprises a first end with a tapering portion as well as a second end on which, preferably, a handle is formed for example in the form of flange.

According to a further embodiment of the invention, the inner surface of the preform is coated with a lubricant, preferably a silicon oil, before the at least one by-pass channel is produced.

This allows the lubricant to be applied on the inner surface of the syringe body in a simple and reliable way.

Once the syringe body and the by-pass channel or by-pass channels formed thereon have been produced, one conveniently, in a first step, introduces a partitioning element into the syringe body so that a first chamber is formed on the side of the first end, which chamber encloses the at least one bypass channel and is separated by the partitioning element from a second chamber on the side of the second end.

The first chamber can then be filled with a first medium and can be closed by fitting a closure on the first end, while the second chamber can be filled with a second medium and can be closed by a plunger which latter is provided with a sealing element intended to seal off the second chamber.

Preferably, the partitioning element and the sealing element consist of an elastomeric material.

The die used for forming the at least one by-pass channel is preferably configured as a split die, consisting of two die halves.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that follows of a preferred embodiment of the invention, with reference to the drawing. In the drawing:

FIG. 1 shows a completely assembled multi-chamber syringe according to the invention;

FIG. 2 shows a longitudinal section through a preform with a die consisting of two halves, indicated schematically only, which is fitted about the outer surface of the preform from the outside for forming the one or more bypass channels in a subsequent process step, under the action of pressure and heat; and

FIG. 3 shows a longitudinal section through the two die halves according to FIG. 1, in an enlarged scale.

### DETAILED DESCRIPTION OF PREFERRED EMBODIMENTS

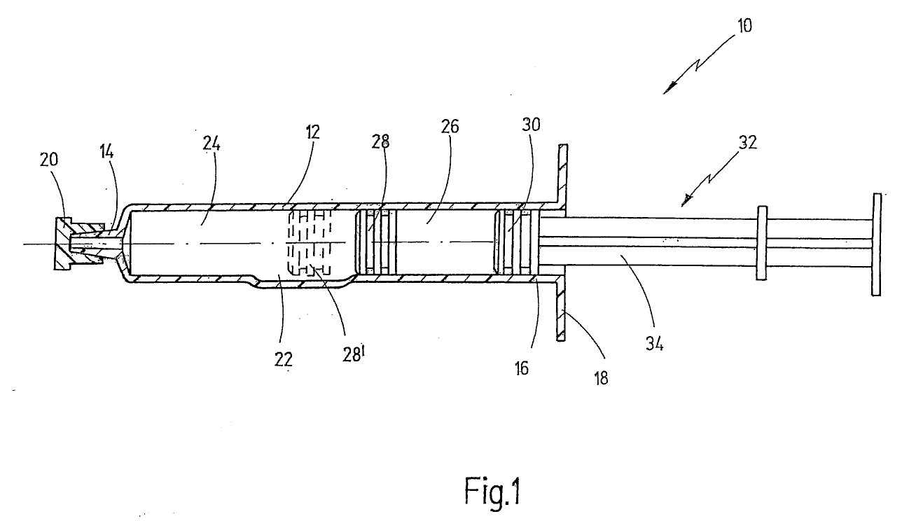

FIG. 1 shows a longitudinal section through a multi-chamber syringe according to the invention, which is indicated in particular by reference numeral 10.

The multi-chamber syringe 10 comprises a syringe body 12 made from a plastic material, with a first end 14 and a second end 16. The first end 14 is configured as a discharge tip and is closed by a closure cap 20.

Other embodiments where a needle is fixed directly on the first end 14, for example by an adhesive or by screwing using a suitable thread, are likewise imaginable.

The second end 16 is closed by a syringe plunger 32 with a plunger rod 34 that is terminated by a sealing element 30 thereby sealing the space in the syringe body 12 from the outside. Inside the syringe body 12, there is further provided a partitioning element 28 in the form of a stopper made from an elastomeric material, which partitions the interior of the syringe body 12 into a first chamber 24 and a second chamber 26. The first chamber 24 is delimited toward the outside by the first end 14 or the fitted closure cap 20, respectively, while the second chamber 26 is closed toward the outside by the sealing element 30 of the syringe plunger 32.

A by-pass channel 22, having an axial extension longer than the extension of the partitioning element 28, is arranged in a central area of the syringe body 12, immediately adjacent the partitioning element 28.

The first chamber 24 may contain a first medication, the second chamber 26 a second medication, for example.

For use, one grips the syringe 10 by one end to push the syringe plunger 34 into the syringe body 12, a handle 18 formed on the second end 16 as a finger flange serving to grip the syringe body 12. During that operation, the system is vented through the first end 14. Now, when the syringe plunger 34 is pushed in, the partitioning element 28 moves in the direction of the first end 14 until it enters the area of the by-pass channel 22 thereby permitting the sub-stances to flow over between the first chamber 24 and the second chamber 26. As the syringe plunger 34 moves on, the sealing element 30 finally comes into contact with the partitioning element 28 so that the two elements 28, 30 can be moved on together. At that point in time, mixing of the two substances, previously contained in chambers 24 and 26, has been completed and the mixed components can be injected by pushing the syringe body 34 still further.

Injection can be effected using an injection needle already applied, or an injection needle that is screwed onto the first end, for example. Other embodiments with or without an injection needle are of course also imaginable. The shape and arrangement of the at least one by-pass channel 22 may vary within wide limits, as is generally known in the art. For example, there may be provided a plurality of by-pass channels 22 that extend along the inner circumferential surface of the syringe body 12 either in axial direction or at an angle relative to the latter. Further, Y-shaped by-pass channels or S-shaped by-pass channels, for example, may be provided as well.

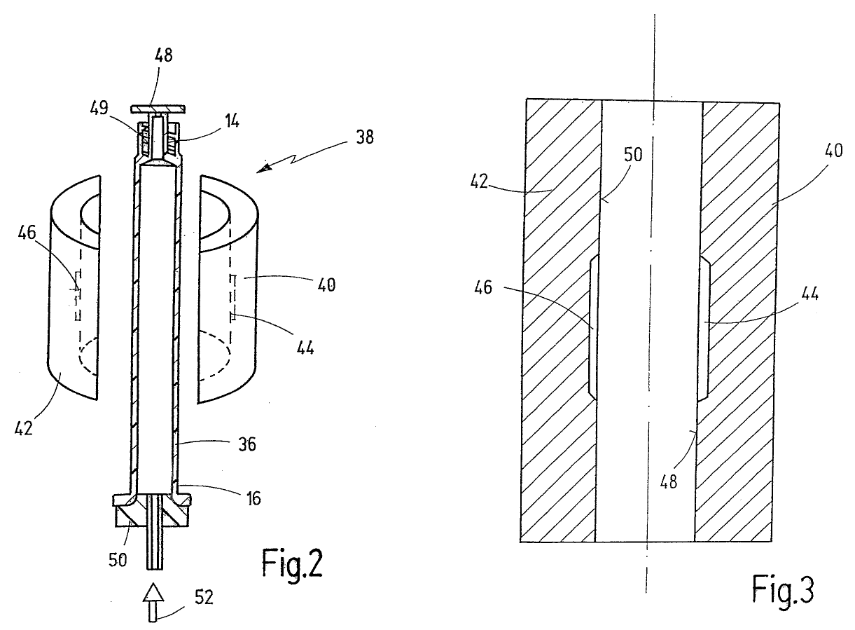

The way of producing such a multi-chamber syringe according to the invention will now be described in more detail with reference to FIGS. 2 and 3.

To begin with, a preform 36 is made from a suitable thermoplastic material. The preform 36 has a tubular, preferably cylindrical shape and already comprises the first end 14 with a discharge tip and the second end 16 with a handle in the form of a finger flange, for example. In FIG. 2, the first end is provided, by way of example, with a Luer Lock thread 49, which allows an injection needle to be screwed on later. The preform 36 is produced in the manner known as such, preferably by injection molding using a suitable mold. The plastic material used may, for example, be a cyclic olefin polymer, such as COC 6013, which is sold by Topas Advanced Polymers GmbH, Industriepark Höchst, Building F 821, 65926 Frankfurt, Germany.

For forming the at least one by-pass channel, the preform 36 is positioned inside a die 38 in which the one or more by-pass channels are pre-formed as recesses in the inner surface. Prior to that operation, the area to be deformed is partially heated, i.e. heated up to the thermoforming range of the particular plastic material used. This is the thermoelastic range where the material is still thermostable, but no longer solid. By simultaneously applying a differential pressure one now forms the at least one by-pass channel under the influence of pressure so that the plastic material will come to apply itself to the recesses 44, 46 in the die 38 thereby forming the at least one by-pass channel.

The die 38 used may be made from tool steel, for example, and is preferably given a two-part design comprising a first die half 40 and a second die half 42 in which the respective by-pass channels to be formed are preformed in the respective inner surface 48, 50 in the form of recesses 44, 46 (negative shape of the by-pass channels) (compare FIG. 3).

The temperature used is dependent on the plastic material used and may generally be between approximately 100° Celsius for low-melting types of plastic materials and up to approximately 250° Celsius for high-temperature types. Also dependent on the particular plastic material used are the pressure required and the deformation time.

For example, when using the before-mentioned COC 6013 material, the wall thickness of the syringe body 36 of a syringe with a capacity of 5 ml is approximately 1.35 mm, in the by-pass area approximately 1.0 mm. For producing the two by-pass channels, the preform 36 is heated up to approximately 170° Celsius and is subjected to a pressure of approximately 3 to 4 bar from the inside, for which purpose the first end 14 is closed by a stopper 48 and the second end 16 is likewise closed by a stopper 50 while the pressure is applied through a suitable supply channel as indicated by arrow 52. The time for which the pressure is applied is approximately 2 seconds.

The dimensions of the by-pass channels used depend on the particular syringe format. For a syringe having a capacity of 5 ml the following dimensions will be normally used:
Depth of channel: 0.4 to 1 mm;
Length of channel: As short as possible, but longer than the partitioning element 28, for example 6 to 12 mm;
Width of channel: Approximately 1 to 4 mm.

As has been mentioned before, the shape of the channel may vary. The number of channels may vary as well and may be influenced by the kind of the substances to be mixed (for example their viscosity). Generally, the channels are kept as short as possible so as not to produce too much of dead volume for the substances to be mixed.

1. A method of producing a multi-chamber syringe having a by-pass channel from a plastic material, comprising the following steps of:
producing a tubular preform from a thermoplastic material;
By providing a die configured to enclose said preform from the outside at least in an area of at least one by-pass channel to be formed, said die comprising a recess on an inner surface thereof for forming said by-pass channel;
heating said preform to a temperature above a softening range of said plastic material and positioning the preform in a predefined axial position inside the die;
subjecting said preform to a differential pressure until said by-pass channel is plastically formed, thereby forming a syringe body; and
cooling said syringe body to room temperature;
wherein said step of subjecting said preform to a differential pressure comprises the step of applying a partial vacuum from the outside.

2. A method of producing a multi-chamber syringe having a by-pass channel from a plastic material, comprising the following steps of:
producing a tubular preform from a thermoplastic material;
providing a die configured to enclose said preform from the outside at least in an area of at least one by-pass channel to be formed, said die comprising a recess on an inner surface thereof for forming said by-pass channel;
heating said preform to a temperature above a softening range of said plastic material and positioning the preform in a predefined axial position inside the die;
subjecting said preform to a differential pressure until said by-pass channel is plastically formed, thereby forming a syringe body; and
cooling said syringe body to room temperature.

3. The method of claim 2, wherein said preform is heated to a temperature within a thermoforming temperature range of said plastic material.

4. The method of claim 2, wherein said preform is subjected to an overpressure from the inside, for forming said by-pass channel.

5. The method of claim 4, wherein said preform is subjected to an overpressure of at least 1.5 bar for forming said by-pass channel.

6. The method of claim 5, wherein said preform is subjected to an overpressure of no more than 8 bars for forming said by-pass channel.

7. The method of claim 2, wherein said heated-up preform after being heated to said above said softening range of said plastic material is subjected to a differential pressure for a period of 1 to 5 seconds for forming said by-pass channel with a wall thickness of 0.5 to 2 mm in the area of said by-pass channel.

8. The method of claim 2, wherein said by-pass channel is plastically formed at a temperature between 140° and 200° Celsius.

9. The method of claim 2, wherein said by-pass channel is plastically formed at a temperature between 160° and 180° Celsius.

10. The method of claim 2, wherein said plastic material is selected from the group formed by a linear olefin polymer, a cyclic olefin polymer, and a cyclic olefin copolymer.

11. The method as defined in claim 2, wherein said preform has a substantially cylindrical shape and comprises a first end with a tapering portion as well as a second end.

12. The method of claim 11, further comprising the step of forming a handle on said second end.

13. The method of claim 2, further comprising the step of applying a lubricant onto said inner surface of said preform before applying said pressure differential.

14. The method of claim 2, further comprising the step of introducing a partitioning element after forming said syringe body so as to form a first chamber on a first end thereof, said first chamber comprising said by-pass channel, and to form a second chamber which is separated and sealed from said first chamber by said partitioning element.

15. The method of claim 14, further comprising the steps of filling said first chamber with a first medium and closing said first chamber by fitting a closure onto said first end.

16. The method of claim 15, further comprising the step of filling said second chamber with a second medium and closing said seconding chamber by applying a plunger comprising a sealing element for sealing off said second chamber.

17. The method of claim 2, wherein said partitioning element and said sealing element consist of an elastomeric material.

18. The method of claim 2, wherein said step of providing a die comprises the steps of a first die half and a second die half mated to each other.

19. A method of producing a multi-chamber syringe having a by-pass channel from a plastic material, comprising the following steps of:
producing a tubular preform from a thermoplastic material selected from the group formed by a linear olefin polymer, a cyclic olefin polymer, and a cyclic olefin copolymer;
providing a die configured to enclose said preform from the outside at least in an area of at least one by-pass channel to be formed, said die comprising a recess on an inner surface thereof for forming said by-pass channel;
heating said preform to a temperature between 140° and 200° Celsius above a softening range of said plastic material and positioning the preform in a predefined axial position inside the die;
subjecting said preform to a differential pressure for a period of 1 to 5 seconds for plastically forming said by-pass channel with a wall thickness of 0.5 to 2 mm.

20. The method of claim 19, further comprising the step of introducing a partitioning element after forming said syringe body so as to form a first chamber on a first end thereof, said first chamber comprising said by-pass channel, and to form a second chamber which is separated and sealed from said first chamber by said partitioning element.
